(19) United States
(12) Patent Application Publication
(10) Pub. No.: US 2023/0196001 A1
(43) Pub. Date: Jun. 22, 2023

(54) SENTENCE CONVERSION TECHNIQUES

(71) Applicant: BEIJING SOGOU TECHNOLOGY DEVELOPMENT CO., LTD., Beijing (CN)

(72) Inventors: Bohuai YAO, Beijing (CN); Xin CUI, Beijing (CN)

(73) Assignee: BEIJING SOGOU TECHNOLOGY DEVELOPMENT CO., LTD., Beijing (CN)

(21) Appl. No.: 18/107,906

(22) Filed: Feb. 9, 2023

Related U.S. Application Data
(63) Continuation of application No. PCT/CN2021/102186, filed on Jun. 24, 2021.

(30) Foreign Application Priority Data
Nov. 20, 2020 (CN) 202011315387.1

(51) Int. Cl. G06F 40/166; G06N 20/00

(52) U.S. Cl. CPC G06F 40/166; G06N 20/00

(57) ABSTRACT

Some aspects of the disclosure provide a method for sentence conversion. The method includes receiving a first sentence that is inputted by a user, inputting the first sentence into a first sentence based rewrite model to obtain a second sentence having a same semantic as the first sentence but a different style from the first sentence. The first sentence based rewrite model converts the first sentence into the second sentence without partitioning the first sentence into smaller portions. The method also includes displaying the second sentence. Apparatus and non-transitory computer-readable storage medium counterpart embodiments are also contemplated

### RELATED APPLICATIONS

The present application is a continuation of International Application No. PCT/CN2021/102186, filed on Jun. 24, 2021 and entitled “INPUT METHOD AND APPARATUS, AND APPARATUS FOR INPUTTING”, which claims priority to Chinese Patent Application No. 202011315387.1, filed on Nov. 20, 2020 and entitled “INPUT METHOD AND APPARATUS, AND APPARATUS FOR INPUTTING”. The entire disclosures of the prior applications are hereby incorporated by reference in their entirety.

### FIELD OF THE TECHNOLOGY

Embodiments of this disclosure relate to the field of computer technologies, including sentence conversion techniques.

### BACKGROUND OF THE DISCLOSURE

In response to the development of computer technologies, an input method application has increasingly abundant functions. For example, when a user inputs a statement through the input method application, the statement inputted by the user or words in the statement may be automatically rewritten to conform to a certain style.

In the related art, a statement rewrite function is usually realized in a rule-based manner. For example, the statement inputted by the user may be spliced with a certain statement in a statement library to realize statement rewrite. For example, a statement “Hahaha” inputted by the user is rewritten into “Hahaha, I laughed out loud”. Alternatively, the words in the statement inputted by the user are replaced with other words to realize statement rewrite. For example, a word “I” is replaced with “Io” (I in Italian). In the related rule-based statement rewrite manner, the rewrite function can be triggered only when the content inputted by the user is a high-frequency statement. Therefore, the generalization performance is poor, and the generated statement is usually relatively stiff, and is not fluent.

### SUMMARY

Embodiments of this disclosure provide an input (e.g., sentence conversion) method and apparatus, and an apparatus for inputting (e.g., sentence conversion), to resolve the technical problems in the related art such as poor generalization performance and poor statement fluency caused by rule-based statement rewrite.

Some aspects of the disclosure provide a method for sentence conversion. The method includes receiving a first sentence that is inputted by a user, inputting the first sentence into a first sentence based rewrite model to obtain a second sentence having a same semantic as the first sentence but a different style from the first sentence. The first sentence based rewrite model converts the first sentence into the second sentence without partitioning the first sentence into smaller portions. The method also includes displaying the second sentence.

Some aspects of the disclosure provide an apparatus for sentence conversion. The apparatus includes processing circuitry configured to receive a first sentence that is inputted by a user, and input the first sentence into a first sentence based rewrite model to obtain a second sentence having a same semantic as the first sentence but a different style from the first sentence. The first sentence based rewrite model converts the first sentence into the second sentence without partitioning the first sentence into smaller portions. The processing circuitry also displays the second sentence.

Some aspects of the disclosure provide a non-transitory computer-readable storage medium storing instructions which when executed by at least one processor cause the at least one processor to perform the method for sentence conversion.

Since the rewrite model is used for the sentence rewrite, a corresponding rewritten sentence can be obtained when a sentence is inputted into the rewrite model. This process is not limited by a use frequency of the sentence, so that the generalization performance of the sentence rewrite function is improved. In addition, the rewrite model is trained through DL. Compared with rule-based sentence rewrite, or word based sentence rewrite, the generated sentences approximate a real corpus to a larger extent, and the fluency of the rewritten sentence is improved.

### BRIEF DESCRIPTION OF THE DRAWINGS

Further features, the nature, and various advantages of the disclosed subject matter will be more apparent from the following detailed description and the accompanying drawings.

FIG. 1 is a step flowchart of an embodiment of an input method according to this disclosure.

FIG. 2 is a step flowchart of another embodiment of an input method according to this disclosure.

FIG. 3 is a step flowchart of still another embodiment of an input method according to this disclosure.

FIG. 4 is a schematic structural diagram of an embodiment of an input apparatus according to this disclosure.

FIG. 5 is a schematic structural diagram of an apparatus for inputting according to this disclosure.

FIG. 6 is a schematic structural diagram of a server side according to some embodiments of this disclosure.

### DESCRIPTION OF EMBODIMENTS

This disclosure is described in further details below with reference to the drawings and the embodiments. It may be understood that, the specific embodiments described herein are merely used for illustrating a related embodiment, and are not limited to the embodiment. Further, for ease of description, only parts relevant to the related embodiments are shown in the drawings.

The embodiments in this disclosure and features in the embodiments may be combined with each other in case of no conflict. This disclosure is described in detail below with reference to the drawings and the embodiments.

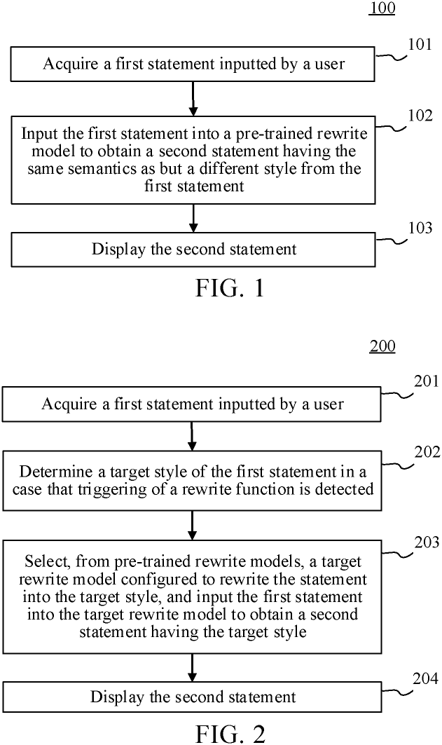

FIG. 1 shows a step process 100 of an embodiment of an input method according to this disclosure. The input method may be executed on various electronic devices, including but not limited to a server, a smart mobile phone, a tablet computer, an e-book reader, a moving picture experts group audio layer III (MP3) player, a moving picture experts group audio layer IV (MP4) player, a laptop portable computer, an on-board computer, a desktop computer, a set-top box, a smart television, and a wearable device.

An input method application mentioned in this embodiment of this disclosure is a software that implements text input. The application may alternatively be referred to as an input method editor, an input method software, an input method platform, an input method framework, an input method system, or the like. A user can conveniently input required characters or character strings into the electronic devices by using the input method application. An input method is a coding method for inputting a plurality of symbols into an electronic device such as a computer and a mobile phone. For example, in addition to a common Chinese input method (such as a pinyin input method, a five-stroke input method, a phonetic input method, a speech input method, and a handwriting input method), input methods for other languages (such as an English input method, a hiragana input method, and a Korean input method) are also supported. An input manner may include but is not limited to a coding input manner and a voice input manner. The language type and the input manner of the input method are not limited herein. It is noted that while a statement is used as an example of a sentence in the following description. In some examples, the embodiments for statements can be suitably modified for other types of sentences.

The input method in this embodiment may include the following steps:

In step 101, a first statement inputted by a user is acquired.

In this embodiment, various types of client applications, such as an input method application, an instant messaging application, a shopping application, a search application, an email client, and a social platform software may be installed on an execution body of the input method (such as the above electronic device). The execution body may acquire in real time the first statement inputted by the user through the input method application. The first statement may be a statement currently being edited by the user but not transmitted. As an example, in a scenario where a local user performs instant messaging with a peer user through an instant messaging application, the first statement may be an instant message currently being edited by the local user but not transmitted to the peer user.

In this embodiment, the input method application may be configured with a rewrite function. The rewrite function allows to rewrite the first statement inputted by the user into another statement, thus providing the user with more abundant available statements.

In step 102, the first statement is input into a pre-trained rewrite model (also referred to as sentence based rewrite model) to obtain a second statement having the same semantics as but a different style from the first statement.

In this embodiment, the above execution body may acquire the first statement inputted by the user and input the first statement into the pre-trained rewrite model to obtain the second statement having the same semantics as but the different style from the first statement. The statement styles may be categorized in advance in a non-limiting manner. For example, the statement styles may be categorized into an arty style, a vernacular style, a humorous style, a formal style, a two-dimensional style, or a joke style.

In this embodiment, the rewrite model may be configured to rewrite the first statement inputted into the rewrite model into another statement having the same semantics but a different style, that is, may represent a correspondence between statements having the same semantics and different styles. The rewrite model may be obtained by pre-training through deep learning (DL). The DL is a study direction of machine learning. Through the DL, an internal law and a representation level of sample data can be learned, and the information obtained during the learning greatly facilitates interpretation of data such as a text, an image, and a sound. An ultimate goal of the DL is to cause a machine to possess analysis and learning capabilities as humans, and to recognize data such as a text, an image, and a sound. Therefore, the rewrite model trained through the DL can learn a rule for rewriting a statement into another statement, so as to realize the statement rewrite function. It is noted that the rewrite model can perform the conversion from the first statement as a whole to the second statement, and thus the rewrite model is also referred to as sentence based rewrite model. The sentence based rewrite model does not perform the conversion using word based replacements for example.

In a scenario, the rewrite model may be deployed locally to the execution body, for example, deployed to a data package of the input method application. In this case, the execution body may directly input the first statement into the rewrite model to obtain the second statement having the same semantics as but the different style from the first statement.

In another scenario, the rewrite model may be deployed on a server side, such as an input method server side. The input method server side is a server side configured to provide support for the input method application. The execution body may transmit the first statement to the server side by transmitting a request to the server side. Upon acquisition of the first statement carried in the request, the server side may input the first statement to the rewrite model and obtain the second statement outputted by the rewrite model. After obtaining the second statement, the server side may return the second statement to the execution body.

In some implementations of this embodiment, the execution body may detect in real time whether the rewrite function is triggered, and input the first statement into the pre-trained rewrite model to obtain the second statement having the same semantics as but the different style from the first statement when detecting that the rewrite function is triggered. In practice, the rewrite function may be triggered by the user or automatically.

As an example, an input method interface may display a keyboard area and various function buttons, such as a voice input function button, an applet function button, a search function button, an expression input function button, and a rewrite function button. The rewrite function of the input method application is triggered when the user triggers (for example, clicks/taps) the rewrite function button. The rewrite function button may be displayed in various styles, and the style of the rewrite function button is not limited in this embodiment.

As another example, the user may trigger the rewrite function by inputting content into the input method application. For example, when the user inputs target content, such as “rewrite the statement” in the coding input manner or the voice input manner, the rewrite function may be triggered.

As still another example, user-related information may be analyzed in real time, and the rewrite function may be automatically triggered when some preset triggering conditions are satisfied. The user-related information may include but is not limited to at least one of a user profile (for example, may include an age, a gender, an occupation, and a region), context information, an input scenario, personal preferences of a user, and historical behavioral data of the user during the input. For example, if the user-related information indicates that the user likes manually triggering the rewrite function in the current input scenario, the rewrite function may be automatically triggered.

As still another example, it may be detected whether the user has a rewrite demand during the input by the user. The rewrite function is triggered when it is detected that the user has a rewrite demand.

The triggering manner of the rewrite function is not limited to the above examples, and is not enumerated herein.

In some implementations of this embodiment, the rewrite model is obtained by training through the following sub-step S11 to sub-step S12.

In sub-step S11, a sample set is acquired.

The sample set may include numerous samples. Each of the samples may be a two-tuple. The two-tuple includes a first sample statement and a second sample statement. The first sample statement and the second sample statement in each two-tuple may have the same semantics but different styles. For example, the first sample statement is a conventional statement, such as a vernacular statement “No one is better than you in my heart”. The second sample statement may be in the arty style, such as “the flowing water, the glowing trees, and the blowing breeze in spring pale in comparison with you”.

In practice, the first sample statement and the second sample statement may be extracted in various corpus extraction manners. During the corpus extraction, corpus mining may be performed based on a feature word, a scenario, a user feature, and the like. Then processing such as de-duplication and filtering may be performed on the mined corpus, to obtain a sample statement, and a style label is added to sample statements of some styles.

In sub-step S12, the rewrite model is obtained by training based on the sample in the sample set.

In some examples, various deep neural networks may be used as an initial model, and the initial model is trained through the DL and the sample set to obtain the rewrite model. As an example, the deep neural network may include but is not limited to a long short-term memory (LSTM), a recurrent neural network (RNN), and a model having encoder and decoder structures.

In practice, different rewrite models may be trained for different styles, so that each rewrite model can rewrite the statement into a style. Alternatively, only one rewrite model is trained so that the rewrite model can rewrite the statement into different styles. Specifically, the initial model may be trained through the DL (such as supervised learning) to obtain the rewrite model. Specifically, some two-tuples may be selected from the sample set, one of sample statements in the two-tuples is used as an input of the initial model and another sample statement is used as an output of the initial model to train the initial model, so as to obtain the rewrite model.

In some other examples, the execution body may obtain the rewrite model by using use the pre-trained model. As an example, the pre-trained model may include but is not limited to a bidirectional encoder representations from transformer (BERT) model, an enhanced language representation with informative entities (ERNIE) model, and an XLNet (a model optimized based on the BERT model). The execution body may retrain the pre-trained model, for example, perform fine-tuning to obtain the rewrite model.

In step 103, the second statement is displayed.

In this embodiment, the execution body may display the second statement on a display interface of the input method application after obtaining the second statement. A display manner and a display position of the second statement are not limited herein. For example, the second statement may be displayed at any position on the display interface of the input method application or at any position in a current input interface in a form of a floating window.

In some implementations of this embodiment, after the second statement is displayed, the first statement may be replaced with the second statement if it is detected that the user triggers the second statement. In addition, the second statement may be displayed on the screen or transmitted. In this way, the input efficiency can be improved for the user.

According to the method provided in the above embodiment of this disclosure, the first statement inputted by the user is acquired, the first statement is inputted into the rewrite model pre-trained through the DL, to obtain the second statement having the same semantics as but the different style from the first statement, and the second statement is displayed for selection by the user. Since the rewrite model is used for the statement rewrite, a corresponding rewritten statement can be obtained when any statement is inputted into the rewrite model. This process is not limited by a use frequency of the statement, so that the generalization performance of the statement rewrite function is improved. In addition, the rewrite model is trained through DL. Compared with rule-based statement rewrite, the generated statements approximate a real corpus to a larger extent, and the fluency of the rewritten statement is improved.

Further, FIG. 2 shows a step process 200 of another embodiment of an input method. The process 200 of the input method includes the following steps:

In step 201, a first statement inputted by a user is acquired.

For step 201 in this embodiment, refer to step 101 of the embodiment corresponding to FIG. 1, and the details are not described herein again.

In step 202, a target style of the first statement is determined in a case that triggering of a rewrite function is detected.

In this embodiment, an execution body of the input method may determine the target style of the first statement inputted by the user when detecting that the rewrite function is triggered. The target style may be a style into which the first statement is to be written.

In some examples, when a user manually triggers the rewrite function and selects a style label, a style corresponding to the style label selected by the user may be used as the target style.

In other examples, when the user selects no style label, or when the rewrite function is automatically triggered, the target style may be determined through the following steps:

First, user-related information is acquired. The user-related information may include but is not limited to at least one of a user profile, user behavior data, historical input content, and user behavior data.

Then feature information is extracted from the user-related information. The feature information may be information used for representing a user feature, and may be expressed in a form of a vector or the like. Each dimension of the vector may correspond to a content in the user-related information.

Finally, the target style is determined based on the feature information. Since a different user has a different feature and a different preference, the preference of the user may be determined through the feature information of the user, thereby determining the target style. In practice, a style prediction model may be used to determine the target style. The style prediction model may be configured to represent a correspondence between the feature information of the user and the target style. For example, the style prediction model may be a correspondence table used representing the user feature and the preferred style, or may be a prediction model obtained by pre-training through machine learning.

In step 203, from a plurality of rewrite models, a target rewrite model configured to rewrite the statement into the target style is selected, and the first statement is input into the target rewrite model to obtain a second statement outputted by the statement rewrite model.

In this embodiment, a plurality of rewrite models may be obtained by pre-training. The different rewrite models are configured to rewrite the statement into different styles. The execution body may select, from the plurality of rewrite models, the target rewrite model configured to rewrite the statement into the target style, and input the first statement into the target rewrite model to obtain the second statement outputted by the statement rewrite model. The second statement herein has the target style and has the same semantics as the first statement.

In this embodiment, the rewrite model may be obtained by training through the DL based on a sample set. A sample in the above sample set is a two-tuple, including a first sample statement and a second sample statement. The first sample statement and the second sample statement in each two-tuple may have the same semantics but different styles.

In this embodiment, the second sample statement in the two-tuple has a style label that indicates a style of the statement. A different style may correspond to a different style label. The style label may include one or more characters. The characters may include but are not limited to letters, numbers, and symbols. The rewrite model may be obtained by training through the following steps:

In step I, the sample set is divided into a plurality of sample subsets according to the style label of the second sample statement.

Each sample subset is configured to train a rewrite model, and the rewrite model trained through a different sample subset is configured to rewrite the statement into a different style. For example, a statement style is pre-divided into an arty style, a humorous style, a formal style, a two-dimensional style, or a joke style. In this case, the style label may be divided into the following five types: an arty style label, a humorous style label, a formal style label, a two-dimensional style label, and a joke style label. The execution body may group two-tuples to which second sample statements with the same style label belong into the same set, so as to obtain five sample subsets. The five sample subsets are configured to train five rewrite models corresponding to different styles.

In step II, a plurality of rewrite models is obtained by training based on the plurality of sample subsets.

For each sample subset, the first sample statement in the sample subset is used as an input and the second sample statement in the sample subset is taken as an output, to obtain the rewrite model by training through the DL. The obtained rewrite model may be configured to rewrite the statement into a style indicated by a style label corresponding to the sample subset. In this way, the different rewrite models may be configured to rewrite the statement into different styles.

Various deep neural networks may be used as an initial model, and the initial model is trained through the DL and the sample subsets to obtain the rewrite models corresponding to the different sample subsets. Alternatively, a pre-trained model may be first acquired, and then fine-tuning is performed on the pre-trained model to obtain the rewrite models corresponding to the different sample subsets.

During the training, the first sample statements in the sample subsets may be inputted into the initial model or the pre-trained model one by one, to obtain statements outputted by the initial model or the pre-trained model. Then a loss value may be determined based on each of the outputted statements and the second sample statement corresponding to the first sample statement. The loss value may represent a difference between the outputted statement and the second sample statement. A larger loss value indicates a larger difference. The loss value may be determined based on a Euclidean distance and the like. Then parameters of the initial model or the pre-trained model may be updated by using the loss value. In this way, each time the first sample statement is inputted, the parameters of the initial model or the pre-trained model may be updated based on the second sample statement corresponding to the first sample statement.

In practice, it may be determined whether the training is completed in a plurality of manners. For example, it may be determined that the training is completed when a similarity between the statement outputted from the initial model or the pre-trained model and the corresponding second sample statement reaches a preset value (such as 95%). As another example, it may be determined that the training is completed the initial model or the pre-trained model is trained a preset quantity of times. When it is determined that the training is completed, the initial model or the pre-trained model after the training may be determined as the rewrite model.

Therefore, the different rewrite models may be obtained by training based on the different sample subsets, and the different rewrite models may be configured to rewrite the statement into the different styles. In a model application stage, if a statement needs to be rewritten, a corresponding rewrite model may be selected according to a required rewrite style to perform a rewrite operation. In this way, different rewrite models may be flexibly selected for statement rewrite in case of rewrite demands of different styles, which improves the flexibility of statement rewrite and the style diversity.

In step 204, the second statement is displaced.

For step 204 in this embodiment, refer to step 103 of the embodiment corresponding to FIG. 1, and the details are not described herein again.

It can be learned from FIG. 2 that compared with the embodiment corresponding to FIG. 1, in the method provided in the above embodiment of this disclosure, the plurality of rewrite models are pre-trained, so that the different rewrite models can rewrite and output statements of different styles. When the first statement needs to be rewritten, the target style to which the first statement needs to be rewritten is determined, and the first statement inputted by the user is inputted into the target rewrite model that can output a statement of the target style, to obtain the second statement having the same semantics as the first statement and having the target style. In this way, different rewrite models may be flexibly selected for statement rewrite in case of rewrite demands of different styles, which improves the flexibility of statement rewrite and the style diversity.

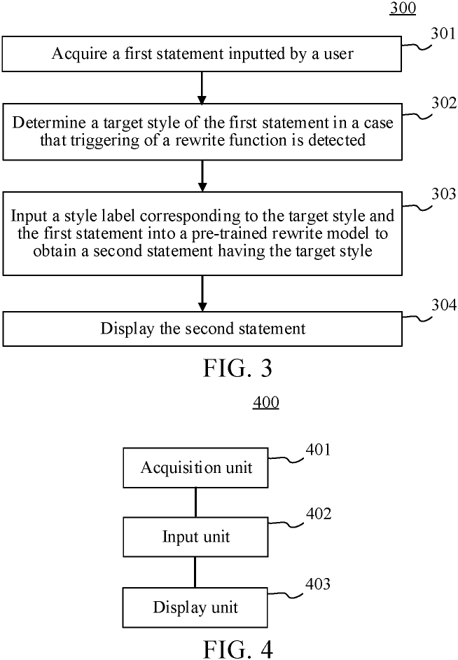

Further, FIG. 3 shows a step process 300 of another embodiment of an input method. The process 300 of the input method includes the following steps:

In step 301, a first statement inputted by a user is acquired.

For step 301 in this embodiment, refer to step 101 of the embodiment corresponding to FIG. 1, and the details are not described herein again.

In step 302, a target style of the first statement is determined in a case that triggering of a rewrite function is detected.

In this embodiment, an execution body of the input method may determine the target style of the first statement inputted by the user when detecting that the rewrite function is triggered. The target style may be a style into which the first statement is to be written.

In some examples, when a user manually triggers the rewrite function and selects a style label, a style corresponding to the style label selected by the user may be used as the target style.

In other examples, when the user selects no style label, or when the rewrite function is automatically triggered, the target style may be determined through the following steps:

First, user-related information is acquired. The user-related information may include but is not limited to at least one of a user profile, user behavior data, historical input content, and user behavior data.

Then feature information may be extracted from the user-related information. The feature information may be information used for representing a user feature, and may be expressed in a form of a vector or the like. Each dimension of the vector may correspond to a content in the user-related information.

Finally, the target style may be determined based on the feature information. Since a different user has a different feature and a different preference, the preference of the user may be determined through the feature information of the user, thereby determining the target style. In practice, a style prediction model may be used to determine the target style. The style prediction model may be configured to represent a correspondence between the feature information of the user and the target style. For example, the style prediction model may be a correspondence table used, or may be a prediction model obtained by pre-training through machine learning.

In step 303, a style label corresponding to the target style and the first statement are input into a pre-trained rewrite model to obtain a second statement outputted by the statement rewrite model.

In this embodiment, the rewrite model may be obtained by pre-training. The rewrite model can rewrite the statement into different styles. An execution body may input the style label corresponding to the target style and the first statement into the pre-trained rewrite model to obtain the second statement outputted by the statement rewrite model. The second statement herein has the target style and has the same semantics as the first statement.

In this embodiment, the rewrite model may be obtained by training through the DL based on a sample set. A sample in the above sample set is a two-tuple, including a first sample statement and a second sample statement. The first sample statement and the second sample statement in each two-tuple may have the same semantics but different styles.

The second sample statement in the two-tuple has a style label that indicates a style of the statement. A different style may correspond to a different style label. The style label may include one or more characters. The characters may include but are not limited to letters, numbers, and symbols. An execution body may use the style labels of the first sample statement and the second sample statement in the two-tuple as an input and the second sample statement in the two-tuple as an output, to obtain the rewrite model by training through DL. The obtained rewrite model may be configured to rewrite the statement into different styles.

Various deep neural networks may be used as an initial model, and the initial model is trained through the DL and samples in the sample set to obtain the rewrite model. Alternatively, a pre-trained model may be first acquired, and then fine-tuning is performed on the pre-trained model to obtain the rewrite model.

During the training, style labels of the first sample statements and the second sample statements in the sample set may be inputted into the initial model or the pre-trained model one by one, to obtain statements outputted by the initial model or the pre-trained model. Then a loss value may be determined based on each of the outputted statements and the second sample statement. The loss value may represent a difference between the outputted statement and the second sample statement. A larger loss value indicates a larger difference. The loss value may be determined based on a Euclidean distance and the like. Then parameters of the initial model or the pre-trained model may be updated by using the loss value. In this way, each time the first sample statement and the style label are inputted, the parameters of the initial model or the pre-trained model may be updated based on the second sample statement.

In practice, it may be determined whether the training is completed in a plurality of manners. As another example, it may be determined that the training is completed when a similarity between the statement outputted from the initial model or the pre-trained model and the corresponding second sample statement reaches a preset value (such as 95%). As another example, it may be determined that the training is completed the initial model or the pre-trained model is trained a preset quantity of times. When it is determined that the training is completed, the initial model or the pre-trained model after the training may be determined as the rewrite model.

Therefore, in a model application stage, if a statement needs to be rewritten, the statement that needs to be rewritten and a style label of a desired style may be inputted into the rewrite model, so as to rewrite the original statement into a statement of the desired style. The rewrite of a statement into a plurality of styles can be realized through only one rewrite model, so that not only the flexibility of statement rewrite and the style diversity are improved, but also a storage space is saved.

In step 304, the second statement is displayed.

For step 304 in this embodiment, refer to step 103 of the embodiment corresponding to FIG. 1, and the details are not described herein again.

It can be learned from FIG. 3 that compared with the embodiment corresponding to FIG. 1, in the method provided in the above embodiment of this disclosure, the rewrite model that can output statements of different styles is pre-trained. When the first statement needs to be rewritten, the first statement and the style label of the target style to which the first statement needs to be rewritten are inputted into the rewrite model, to obtain the second statement having the same semantics as the first statement and having the target style. Therefore, the rewrite of a statement into a plurality of styles can be realized through only one rewrite model, so that not only the flexibility of statement rewrite and the style diversity are improved, but also a storage space is saved.

With further reference to FIG. 4, this disclosure provides an embodiment of an input apparatus as an implementation of the method shown in the above figures. The apparatus embodiment corresponds to the method embodiment shown in FIG. 1, and the apparatus may be specifically applied to a plurality of electronic devices.

As shown in FIG. 4, the input apparatus 400 in this embodiment includes: an acquisition unit 401, configured to acquire a first statement inputted by a user; an input unit 402, configured to input the first statement into a pre-trained rewrite model to obtain a second statement having the same semantics as but a different style from the first statement in a case that triggering of a rewrite function is detected; and a display unit 403, configured to display the second statement. One or more modules, submodules, and/or units of the apparatus can be implemented by processing circuitry, software, or a combination thereof, for example.

In some implementations of this embodiment, the rewrite model is obtained by training through the following steps: acquiring a sample set, a sample in the sample set being a two-tuple, the two-tuple including a first sample statement and a second sample statement, and the first sample statement and the second sample statement having the same semantics but different styles; and obtaining the rewrite model by training based on the sample in the sample set.

In some implementations of this embodiment, the second sample statement in the two-tuple has a style label; and the obtaining the rewrite model by training based on the sample in the sample set includes: dividing the sample set into a plurality of sample subsets according to the style label of the second sample statement; and obtaining a plurality of rewrite models by training based on samples in the plurality of sample subsets, the different rewrite models being configured to rewrite the statement into different styles.

In some implementations of this embodiment, the second sample statement in the two-tuple has a style label; and the obtaining the rewrite model by training based on the sample in the sample set includes: obtaining the rewrite model by training through DL by using the style label of the second sample statement in the sample and the first sample statement as an input and the second sample statement in the sample as an output.

In some implementations of this embodiment, the obtaining the rewrite model by training through DL includes: acquiring a pre-trained model; and retraining the pre-trained model to obtain the rewrite model.

In some implementations of this embodiment, the input unit 402 is further configured to: determine a target style of the first statement in a case that triggering of a rewrite function is detected; and select, from the plurality of rewrite models, a target rewrite model configured to rewrite the statement into the target style, and input the first statement into the target rewrite model to obtain the second statement having the target style.

In some implementations of this embodiment, the input unit 402 is further configured to: determine a target style of the first statement in a case that triggering of a rewrite function is detected; and input a style label corresponding to the target style and the first statement into the rewrite model to obtain the second statement having the target style.

In some implementations of this embodiment, the input unit 402 is further configured to: determine, as the target style of the first statement, a style indicated by a style label selected by a user; or acquire user-related information, extract feature information from the user-related information, and determine the target style of the first statement based on the feature information.

In some implementations of this embodiment, the input unit 402 is further configured to: input the first statement into a pre-trained rewrite model to obtain a second statement having the same semantics as but a different style from the first statement in a case that triggering of a rewrite function is detected, a triggering manner of the rewrite function including triggering by a user and automatic triggering; the triggering by a user including at least one of triggering a rewrite function button and inputting target content; and the automatic triggering including at least one of detecting that a user has a rewrite demand and detecting that a preset triggering condition is satisfied.

In some implementations of this embodiment, the apparatus further includes: a replacement unit, configured to replace the first statement with the second statement in a case that triggering performed by a user on the second statement is detected.

According to the apparatus and provided in the above embodiment of this disclosure, the first statement inputted by the user is acquired, the first statement is inputted into the rewrite model pre-trained through the DL, to obtain the second statement having the same semantics as but the different style from the first statement, and the second statement is displayed for selection by the user. Since the rewrite model is used for the statement rewrite, a corresponding rewritten statement can be obtained when any statement is inputted into the rewrite model. This process is not limited by a frequency of the statement, so that the generalization performance of the statement rewrite function is improved. In addition, the rewrite model is trained through DL. Compared with rule-based statement rewrite, the generated statements approximate a real corpus to a larger extent, and the fluency of the rewritten statement is improved.

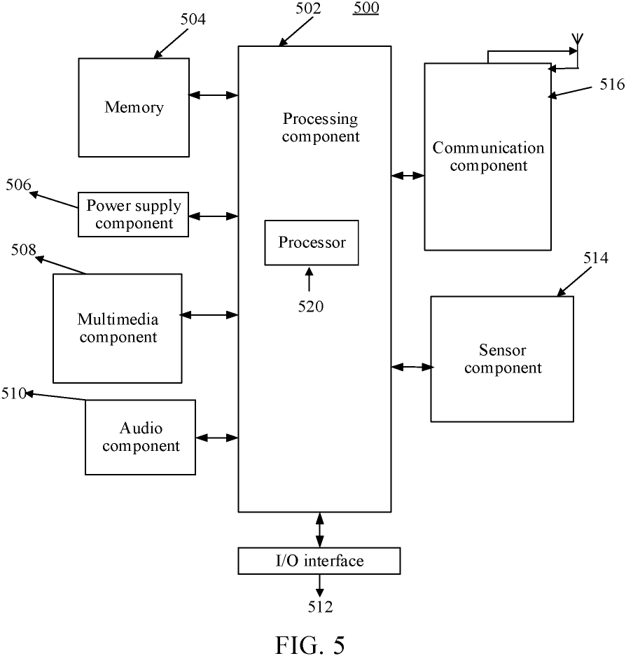

FIG. 5 is a block diagram of an apparatus 500 for inputting according to an exemplary embodiment. The apparatus 500 may be a smart terminal or a server side. For example, the apparatus 500 may be a mobile phone, a computer, a digital broadcasting terminal, a message transceiver device, a game console, a tablet device, a medical device, a fitness facility, a personal digital assistant, or the like.

Referring to FIG. 5, the apparatus 500 may include one or more of the following components: a processing component 502, a memory 504, a power supply component 506, a multimedia component 508, an audio component 510, an input/output (I/O) interface 512, a sensor component 514, and a communication component 516.

The processing component 502 usually controls an overall operation of the apparatus 500, such as operations associated with displaying, a phone call, data communication, a camera operation, and a recording operation. The processing component 502 may include processing circuitry, such as one or more processors 520 to execute instructions, to complete all or some steps of the above method. In addition, the processing component 502 may include one or more modules, to facilitate interaction between the processing component 502 and other components. For example, the processing component 502 may include a multimedia module, to facilitate interaction between the multimedia component 508 and the processing component 502.

The memory 504 is configured to store a plurality of types of data to support operations in the apparatus 500. Examples of the data include instructions, contact data, phonebook data, messages, pictures, videos, and the like of any application or method to be executed in the apparatus 500. The memory 504 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, and a magnetic disk or an optical disk.

The power supply component 506 provides power to the various components of the apparatus 500. The power supply component 506 may include a power supply management system, one or more power supplies, and other components associated with generation, management, and allocation of power for the apparatus 500.

The multimedia component 508 includes a screen providing an output interface between the apparatus 500 and a user. In some embodiments, the screen may include a liquid crystal display (LCD) and a touch panel (TP). If the screen includes the TP, the screen may be implemented as a touchscreen, to receive an input signal from the user. The TP includes one or more touch sensors to sense touch, sliding, and gestures on the TP. The touch sensor may not only sense a boundary of a touch or sliding operation, but also detect a duration and a pressure related to the touch or sliding operation. In some embodiments, the multimedia component 508 includes a front camera and/or a rear camera. When the apparatus 500 is in an operation mode, such as a photographing mode or a video mode, the front camera and/or the rear camera may receive external multimedia data. Each front camera and each rear camera may be a fixed optical lens system or have a focal length and an optical zooming capability.

The audio component 510 is configured to output and/or input an audio signal. For example, the audio component 510 includes a microphone (MIC). When the apparatus 500 is in the operation mode, such as a call mode, a recording mode, and a voice recognition mode, the MIC is configured to receive an external audio signal. The received audio signal may be further stored in the memory 504 or transmitted through the communication component 516. In some embodiments, the audio component 510 further includes a loudspeaker configured to output the audio signal.

The I/O interface 512 provides an interface between the processing component 502 and a peripheral interface module. The peripheral interface module may be a keyboard, a click wheel, a button, or the like. The button may include but is not limited to a homepage button, a volume button, a start button, and a lock button.

The sensor component 514 includes one or more sensors configured to provide state assessment of various aspects for the apparatus 500. For example, the sensor component 514 may detect an on/off state of the apparatus 500 and relative positioning of the components. For example, the components are a display and a small keyboard of the apparatus 500. The sensor component 514 may further detect a position change of the apparatus 500 or a component of the apparatus 500, existence or nonexistence of contact between the user and the apparatus 500, an azimuth or an acceleration/deceleration of the apparatus 500, and a temperature change of the apparatus 500. The sensor component 514 may include a proximity sensor configured to detect existence of nearby objects without any physical contact. The sensor component 514 may further include an optical sensor, such as a CMOS or CCD image sensor for use in an imaging application. In some embodiments, the sensor component 514 may further include an acceleration sensor, a gyroscope sensor, a magnetic sensor, a pressure sensor, or a temperature sensor.

The communication component 516 is configured to facilitate wired or wireless communication between the apparatus 500 and other devices. The apparatus 500 may be connected to a wireless network based on communication standards, such as Wi-Fi, a 2G network, or a 3G network, or a combination thereof. In an exemplary embodiment, the communication component 516 receives a broadcast signal or broadcast-related information from an external broadcast management system through a broadcast channel. In an exemplary embodiment, the communication component 516 further includes a near field communication (NFC) module to facilitate short range communication. For example, the NFC module may be implemented based on a radio frequency identification (RFID) technology, an infra-red data association (IrDA) technology, an ultra wideband (UWB) technology, a Bluetooth (BT) technology, and other technologies.

In an exemplary embodiment, the apparatus 500 may be implemented using processing circuitry, such as one or more application specific integrated circuits (ASIC), a digital signal processor (DSP), a digital signal processing device (DSPD), a programmable logic device (PLD), a field programmable gate array (FPGA), a controller, a micro-controller, a microprocessor or other electronic elements, so as to perform the above method.

In an exemplary embodiment, a non-transitory computer-readable storage medium including instructions, for example, a memory 504 including instructions, is further provided, and the above instructions may be executed by a processor 520 of the apparatus 500 to complete the above method. For example, the non-transitory computer-readable storage medium may be a ROM, a random access memory (RAM), a CD-ROM, a magnetic tape, a floppy disk, an optical data storage device, or the like.

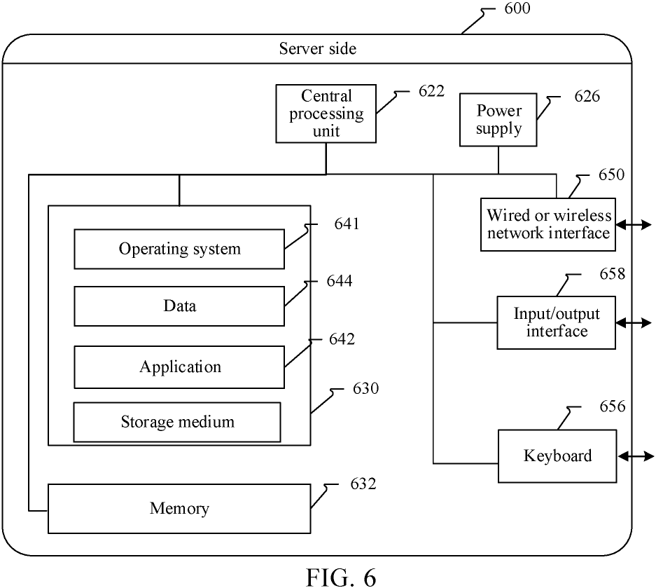

FIG. 6 is a schematic structural diagram of a server side according to some embodiments of this disclosure. The server side 600 may vary considerably depending on configuration or performance, and may include one or more central processing units (CPU) 622 (for example, one or more processors), a memory 632, and one or more storage media 630 (for example, one or more massive storage devices) storing an application 642 or data 644. The memory 632 and the storage medium 630 may provide transitory storage or persistent storage. The program stored in the storage medium 630 may include one or more modules (not shown), and each of the modules may include a series of instruction operations on the server side. Further, the CPU 622 may be configured to communicate with the storage medium 630, and perform the series of instruction operations in the storage medium 630 on the server side 600.

The server side 600 may further include one or more power supplies 626, one or more wired or wireless network interfaces 650, one or more input/output interfaces 658, one or more keyboards 656, and/or one or more operating systems 641, such as Windows ServerTM, Mac OS XTM, UnixTM, LinuxTM, and FreeBSDTM.

A non-transitory computer-readable storage medium is provided. Instructions in the storage medium, when executed by a processor of an apparatus (a smart terminal or a server side), cause the apparatus to perform an input method. The method includes: acquiring a first statement inputted by a user; inputting the first statement into a pre-trained rewrite model to obtain a second statement having the same semantics as but a different style from the first statement; and displaying the second statement.

It is noted that a person skilled in the art can recognize other implementations of this disclosure after considering the description and practicing this disclosure that is disclosed herein. This disclosure is intended to cover any variations, usages, or adaptive changes of this disclosure. These variations, usages, or adaptive changes follow the general principles of this disclosure and include common general knowledge or common technical means in the art not disclosed in the present disclosure. The description and the embodiments are considered as merely exemplary, and the scope and spirit of this disclosure are indicated by the following claims.

It is to be understood that this disclosure is not limited to the precise structures described above and shown in the drawings, and various modifications and changes may be made without departing from the scope of this disclosure.

The above description is some embodiments of this disclosure, and is not intended to limit this disclosure. Any modification, equivalent replacement, or improvement made within the spirit and principle of this disclosure shall fall within the protection scope of this disclosure.

The input method and apparatus, and the apparatus for inputting provided in the embodiments of this disclosure are described in detail above. The principles and the implementations of this disclosure are illustrated by using specific examples. The description of the above embodiments is merely used for facilitating understanding of the method of this disclosure. Moreover, for a person of ordinary skill in the art, there will be changes in the specific implementations and the disclosure scope according to the idea of this disclosure. To conclude, the description should not be understood as a limitation of this disclosure.

What is claimed is:

1. A method for sentence conversion, comprising:
receiving a first sentence that is inputted by a user;
inputting the first sentence into a first sentence based rewrite model to obtain a second sentence having a same semantic as the first sentence but a different style from the first sentence, the first sentence based rewrite model converting the first sentence into the second sentence without partitioning the first sentence into smaller portions; and
displaying the second sentence.

2. The method according to claim 1, further comprising:
acquiring a sample set that comprises one or more samples, a sample in the sample set being a two-tuple sample that comprises a first sample sentence and a second sample sentence, and the first sample sentence and the second sample sentence having a same semantic but of different styles; and
training the first sentence based rewrite model based on the one or more samples in the sample set.

3. The method according to claim 2, wherein the second sample sentence in the two-tuple sample has a style label associated with the second sample sentence, the style label is selected from a plurality of style labels; and
the training the first sentence based rewrite model comprises:
dividing the sample set into a plurality of sample subsets according to the plurality of style labels; and
training a plurality of sentence based rewrite models respectively associated with the plurality of style labels based on the plurality of sample subsets, the plurality of sentence based rewrite models including the first sentence based rewrite model.

4. The method according to claim 2, wherein the second sample sentence in the two-tuple sample has a style label associated with the second sample sentence, the style label is selected from a plurality of style labels; and
training the first sentence based rewrite model comprises:
training the first sentence based rewrite model that has a deep learning (DL) architecture based on the sample set, the second sample sentence being an output from the first sentence based rewrite model in response to the style label of the second sample sentence and the first sample sentence being inputs to the first sentence based rewrite model.

5. The method according to claim 2, wherein the training the first sentence based rewrite model comprises:
acquiring a pre-trained model; and
retraining the pre-trained model to obtain the first sentence based rewrite model.

6. The method according to claim 1, further comprising:
determining a target style for converting the first sentence in response to a detection of a triggering of a rewrite function; and
selecting, from a plurality of sentence based rewrite models respectively associated with a plurality of style labels, the first sentence based rewrite model associated with a style label for the target style.

7. The method according to claim 1, further comprising:
determining a target style for converting the first sentence in response to a detection of a triggering of a rewrite function; and
inputting a style label for the target style along with the first sentence into the first sentence based rewrite model to obtain the second sentence having the target style.

8. The method according to claim 1, further comprising:
determining, a target style for converting the first sentence, according to a style label selected by the user; or
determining, the target style for converting the first sentence according to feature information that is extracted from user-related information.

9. The method according to claim 1, wherein the inputting the first sentence comprises:
inputting the first sentence into the first sentence based rewrite model to obtain the second sentence in response to a detection of a triggering of a rewrite function,
the triggering of the rewrite function comprising at least one of a triggering by the user and an automatic triggering;
the triggering by the user comprising at least one of triggering a button associated with the rewrite function and receiving a predefined content input associated with the rewrite function; and
the automatic triggering comprising at least one of detecting that a rewrite demand has been setup for the user and detecting that a preset triggering condition is satisfied.

10. The method according to claim 1, wherein after the displaying the second sentence, the method further comprises:
replacing the first sentence with the second sentence in response to a detection of a user response to the second sentence that is displayed.

11. An apparatus for sentence conversion, comprising processing circuitry configured to:
receive a first sentence that is inputted by a user;
input the first sentence into a first sentence based rewrite model to obtain a second sentence having a same semantic as the first sentence but a different style from the first sentence, the first sentence based rewrite model converting the first sentence into the second sentence without partitioning the first sentence into smaller portions; and
display the second sentence.

12. The apparatus according to claim 11, wherein the processing circuitry is configured to:
acquire a sample set that comprises one or more samples, a sample in the sample set being a two-tuple sample that comprises a first sample sentence and a second sample sentence, and the first sample sentence and the second sample sentence having a same semantic but of different styles; and
train the first sentence based rewrite model based on the one or more samples in the sample set.

13. The apparatus according to claim 12, wherein the second sample sentence in the two-tuple sample has a style label associated with the second sample sentence, the style label is selected from a plurality of style labels, the processing circuitry is configured to:
divide the sample set into a plurality of sample subsets according to the plurality of style labels; and
train a plurality of sentence based rewrite models respectively associated with the plurality of style labels based on the plurality of sample subsets, the plurality of sentence based rewrite models including the first sentence based rewrite model.

14. The apparatus according to claim 12, wherein the second sample sentence in the two-tuple sample has a style label associated with the second sample sentence, the style label is selected from a plurality of style labels, the processing circuitry is configured to:
train the first sentence based rewrite model that has a deep learning (DL) architecture based on the sample set, the second sample sentence being an output from the first sentence based rewrite model in response to the style label of the second sample sentence and the first sample sentence being inputs to the first sentence based rewrite model.

15. The apparatus according to claim 12, wherein the processing circuitry is configured to:
acquire a pre-trained model; and
retrain the pre-trained model to obtain the first sentence based rewrite model.

16. The apparatus according to claim 11, wherein the processing circuitry is configured to:
determine a target style for converting the first sentence in response to a detection of a triggering of a rewrite function; and
select, from a plurality of sentence based rewrite models respectively associated with a plurality of style labels, the first sentence based rewrite model associated with a style label for the target style.

17. The apparatus according to claim 11, wherein the processing circuitry is configured to:
determine a target style for converting the first sentence in response to a detection of a triggering of a rewrite function; and
input a style label for the target style along with the first sentence into the first sentence based rewrite model to obtain the second sentence having the target style.

18. The apparatus according to claim 11, wherein the processing circuitry is configured to:
determine, a target style for converting the first sentence, according to at least one of a style label selected by the user and/or feature information that is extracted from user-related information.

19. The apparatus according to claim 11, wherein the processing circuitry is configured to:
input the first sentence into the first sentence based rewrite model to obtain the second sentence in response to a detection of a triggering of a rewrite function,
the triggering of the rewrite function comprising at least one of a triggering by the user and an automatic triggering;
the triggering by the user comprising at least one of triggering a button associated with the rewrite function and receiving a predefined content input associated with the rewrite function; and
the automatic triggering comprising at least one of detecting that a rewrite demand has been setup for the user and detecting that a preset triggering condition is satisfied.

20. The apparatus according to claim 11, wherein the processing circuitry is configured to:
after displaying the second sentence, replace the first sentence with the second sentence in response to a detection of a user response to the second sentence that is displayed.
